(19) United States
(12) Patent Application Publication
(10) Pub. No.: US 2011/0230221 A1
(43) Pub. Date: Sep. 22, 2011

(54) BASE STATION DEVICE AND METHOD OF CONTROLLING BASE STATION DEVICE

(75) Inventor: Takehiro Hara, Kanagawa (JP)

(73) Assignee: KYOCERA CORPORATION, Kyoto (JP)

(21) Appl. No.: 13/130,462

(22) PCT Filed: Nov. 19, 2009
(86) PCT No.: PCT/JP2009/069616

§ 371 Date: May 20, 2011

(30) Foreign Application Priority Data
Nov. 26, 2008 (JP) 2008-301769

(51) Int. Cl. H04B 7/24

(52) U.S. Cl. 455/507

(57) ABSTRACT

Provided is a base station device capable of, when there is no downlink communication data to be transmitted at a given frequency while performing communication at the given frequency, preventing a neighboring base station device from starting communication that uses the given frequency. The base station device (101) provided with a plurality of antennas includes; a wireless control section (104) for recognizing presence of the downlink communication data with respect to a mobile station device; and a transmission processing section (106) for, when the downlink communication data is present, transmitting the downlink communication data to the mobile station device by using the plurality of antennas, and, when the downlink communication data is not present, performing omni transmission processing in which dummy data is transmitted omnidirectionally at least once in a given period of time through the plurality of antennas at the same frequency as is used for the downlink communication data.

### TECHNICAL FIELD

The present invention relates to a base station device and a method of controlling a base station device.

### BACKGROUND ART

In a wireless communication system including a plurality of base station devices and a plurality of mobile station devices, the base station devices and the mobile station devices both communicate over communication channels, which being communication paths included within a given frequency band used by the wireless communication system. The base station devices each allocate a communication channel to be used to the mobile station device that performs communication with the base station device.

In the allocation, the mobile station device performs interference level measurement called carrier sense on communication channels intended to be used, to thereby select and notify to the base station device a communication channel where the interference level is equal to or lower than a given value, and the base station device establishes the allocation of the communication channel as the one to be used.

This is for preventing communication over a communication channel where the interference level is high because such high interference level may consequently deteriorate communication quality.

There has been known a wireless communication system in which a base station device is provided with an adaptive array antenna to form transmission beams having different directivity patterns for different mobile station devices, and transmits the radio waves concurrently to the respective mobile station devices.

In this type of wireless communication system, when transmitting a signal to one of the mobile station devices, the base station device performs control directing the transmission beam toward the direction of the transmission recipient mobile station device by adaptive beamforming, and directing null points of the directive pattern toward the directions of the other mobile station devices than the transmission recipient by adaptive null steering.

When receiving a signal from one of the mobile station devices, too, the base station device directs the reception beam toward the direction of the sender mobile station device (desired wave direction) by adaptive beamforming, and directs null points of the directive pattern toward the directions of the other mobile station devices than the sender (interference wave directions) by adaptive null steering.

In the case where a base station device and a mobile station device are communicating over a communication channel, and another mobile station device performs carrier sense on the communication channel while there is data to be transmitted and the communication therefore continues, a signal present in the communication channel is recognized as an interference wave, which makes the communication channel unavailable for use by the another mobile station device.

However, in a temporary period where there is no data to be transmitted, no communication is being held over the communication channel, and thus another mobile station device which performs carrier sense on the communication channel may determine that there is no interference wave in the communication channel and use the communication channel for the communication to another base station device.

In order to avoid this, a signal containing dummy data which is called a DTX signal is transmitted for the duration of a given period of time (retention period) when a communication channel used by a base station device and a mobile station device shifts from a state in which there is downlink communication data to be transmitted to a state in which there is no downlink communication data to be transmitted. During the retention period, other mobile station devices are thus prevented from determining the communication channel as available for use.

Patent Literature 1 describes a base station device using an adaptive array antenna that expands its service area by switching the signal beam direction at a given timing.

### Prior Art Document

### Patent Document

Patent Literature 1: JP 9-186643 A

### DISCLOSURE OF THE INVENTION

### Problems to be Solved by the Invention

In a base station device that uses an adaptive array antenna, the transmission of signals having the same phase and the same amplitude from a plurality of antennas generates a plurality of beam directions and a plurality of null directions, which gives the transmission beam pattern a shape greatly different from a circle centered around the base station device. FIG. 7 is a diagram illustrating an example of a transmission beam pattern (a diagram expressing the levels of transmission from the base station device toward 360-degree directions, with the base station device at the center) that is formed when a plurality of antennas all transmit signals having the same phase and the same amplitude.

With the transmission beam pattern shaped greatly differently from a circle that is centered around the base station device, a mobile station device located in a null direction cannot receive a signal from this base station device in some cases, even when the mobile station device is within the cell.

Assume that the mobile station device described above is the another mobile station device which is not communicating with this base station device, and that the base station device is transmitting a DTX signal because there is temporarily no communication data in a communication channel over which the base station device is communicating with the current communication partner mobile station device. In this case, when the another mobile station device performs carrier sense, the DTX signal transmitted from the base station device is not received and the communication channel on which the carrier sense has been performed is determined as available for use. Then, the another mobile station device starts communicating with another base station device over this communication channel, and interferes with communication of the original base station device that uses signals of the communication channel, thereby giving rise to problems such as cross talk.

The present invention has been made in view of the problem described above, and an object of the present invention is to provide a base station device and a method of controlling a base station device, which are capable of, when there is no downlink communication data to be transmitted in a communication channel over which communication is being held, preventing other base station devices from starting communication that uses this communication channel. In the following description, “other base station devices” are reworded as “neighboring base station devices”.

### Means for Solving the Problems

A base station device provided with a plurality of antennas according to the present invention includes: data recognizing means for recognizing presence of downlink communication data with respect to a mobile station device; and transmission means for: transmitting the downlink communication data to the mobile station device by using the plurality of antennas, when the downlink communication data is present; and performing omni transmission processing in which dummy data is transmitted omnidirectionally at least once by using the plurality of antennas at the same frequency as is used for the downlink communication data, when the downlink communication data is not present.

According to the present invention, the base station device transmits dummy data at least once to neighboringbase station devices located in 360-degree directions, and the neighboring base station devices do not start communication using a frequency at which the dummy data is transmitted.

Further, in the base station device according to present invention, the omni transmission processing is executed for a duration of a given period of time.

Further, in the base station device according to the present invention, the omni transmission processing is executed until the base station turns from a state in which the downlink communication data is not present into a state in which the downlink communication data is present.

Further, in the base station device according to present invention, the dummy data is transmitted during the omni transmission processing by using different transmission beam patterns sequentially.

Further, in the base station device according to the present invention, the dummy data is transmitted by using a transmission beam pattern that rotates at least once during the omni transmission processing.

Further, in the base station device according to the present invention, the transmission means transmits the dummy data in the same time slot as is used for the downlink communication data.

According to the present invention, there is provided a method of controlling a base station device provided with a plurality of antennas including the steps of: recognizing presence of downlink communication data with respect to a mobile station device; transmitting the downlink communication data to the mobile station device by using the plurality of antennas, when the downlink communication data is present; and performing omni transmission processing in which dummy data is transmitted omnidirectionally at least once through the plurality of antennas at the same frequency as is used for the downlink communication data, when the downlink communication data is not present.

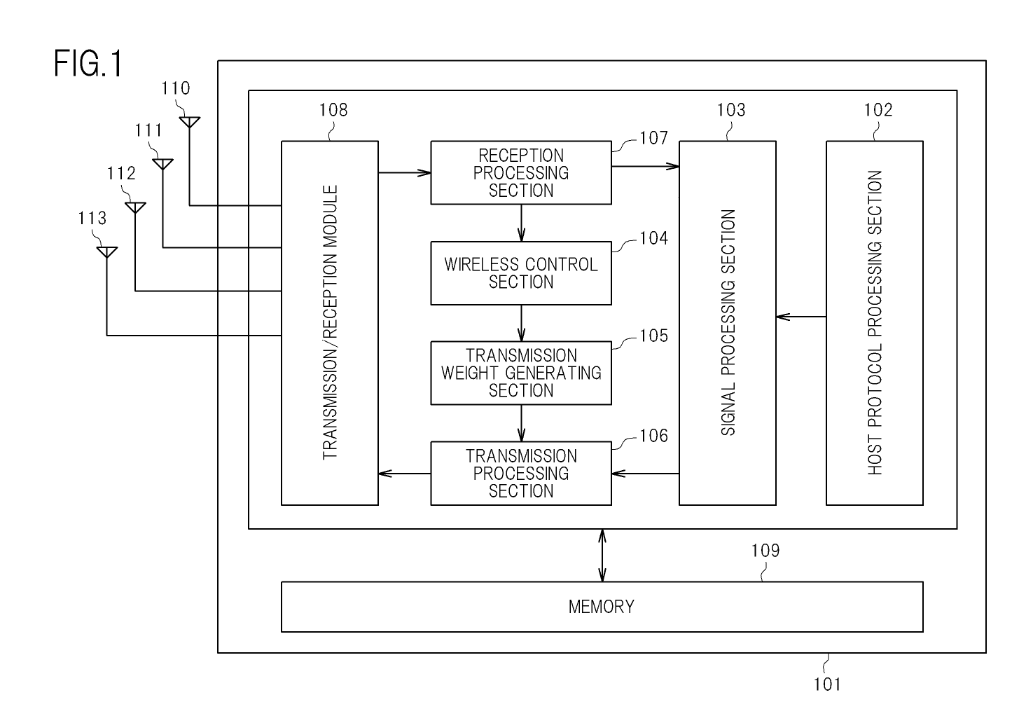

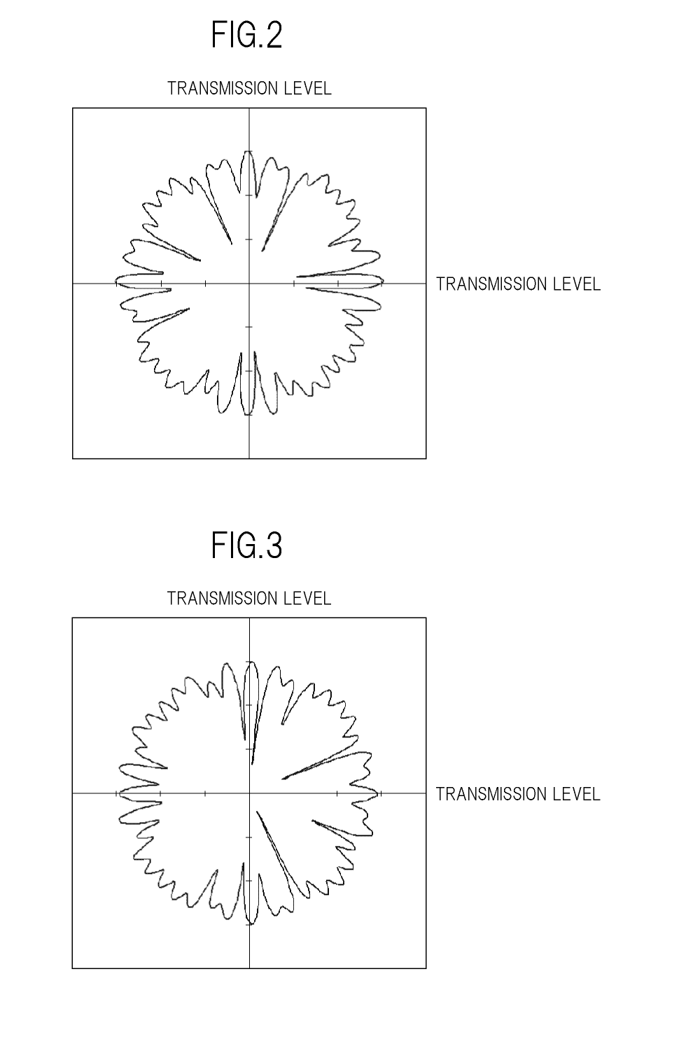

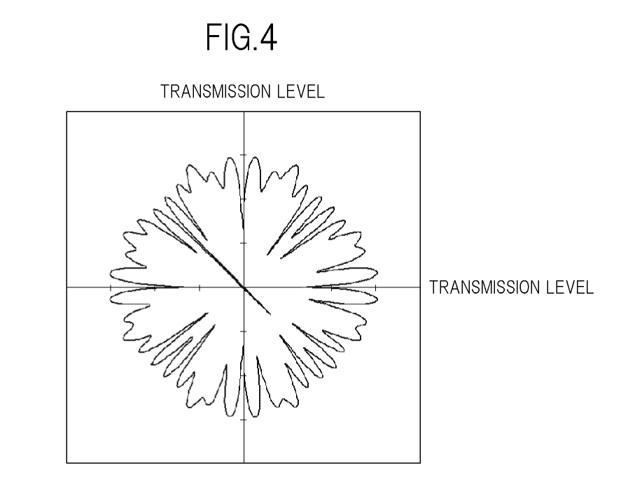

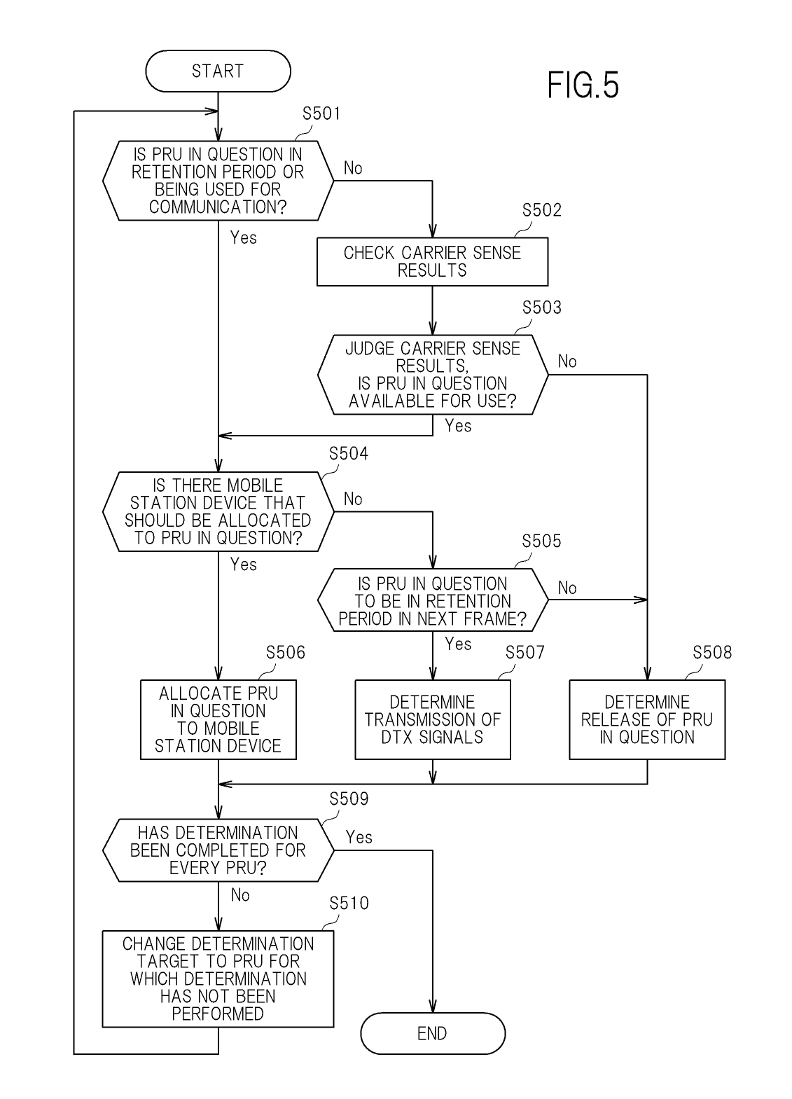

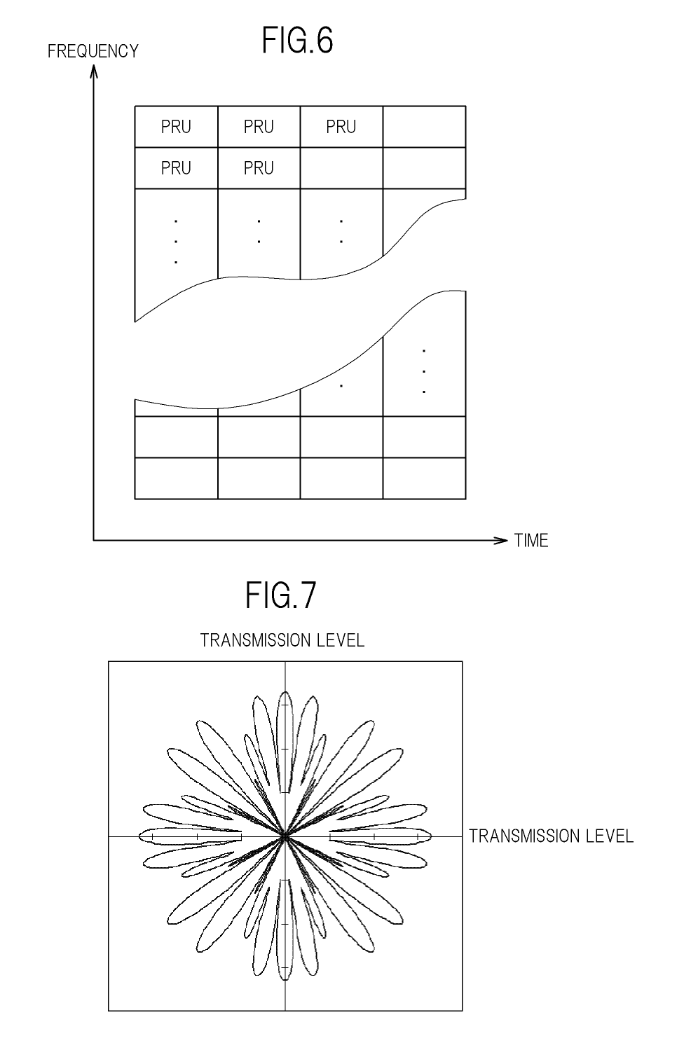

### BRIEF DESCRIPTION OF THE DRAWINGS

[FIG. 1] A diagram illustrating a configuration of a base station device according to an embodiment of the present invention.

[FIG. 2] A diagram illustrating a transmission beam pattern formed by a plurality of antennas.

[FIG. 3] A diagram illustrating a transmission beam pattern formed by a plurality of antennas.

[FIG. 4] A diagram illustrating a transmission beam pattern formed by a plurality of antennas.

[FIG. 5] A flowchart illustrating an operation of the base station device according to the embodiment.

[FIG. 6] A diagram illustrating an example of PRUs.

[FIG. 7] A diagram illustrating an example of a transmission beam pattern that is formed when a plurality of antennas all transmit signals having the same phase and the same amplitude.

### BEST MODE FOR CARRYING OUT THE INVENTION

This embodiment describes a configuration of a base station device that uses a plurality of transmission beam patterns different from one another, in terms of direction in which the transmission distance is short, to transmit DTX signals containing dummy data.

FIG. 1 is a diagram illustrating the configuration of a base station device 101 according to this embodiment.

By Orthogonal Frequency Division Multiple Access (OFDMA) and Time Division Multiple Access (TDMA), the base station device 101 allocates a signal contained in a frequency band and a time domain that are shared with neighboring base station devices to each mobile station device to communicate with the mobile station device. The base station device 101 allocates several subchannels called physical resource units (PRUs) , which are defined by a given number of subcarriers and a given number of time slots, to the communication with a mobile station device. FIG. 6 is a diagram illustrating an example of PRUs.

When a neighboring base station device which is not the base station device 101 is using a PRU for the communication with a mobile station device different from the one with which the base station device 101 communicates, the interference level in this PRU can be high for the base station device 101 and, if the interference level exceeds a threshold set in advance, the base station device 101 cannot use the PRU. The base station device 101 causes a mobile station device that is planning to start communication to perform carrier sense for measuring the interference level in PRUs that are not being used by the base station device 101, and allocates a PRU where the interference level is lower than the threshold to the communication with this mobile station device.

The base station device 101 communicates with mobile station devices from antennas 110, 111, 112, and 113 through existing adaptive array antenna processing.

The base station device 101 includes a host protocol processing section 102, a signal processing section 103, a wireless control section 104, a transmission weight generating section 105, a transmission processing section 106, a reception processing section 107, a transmission/reception module 108, a memory 109, and the antennas 110, 111, 112, and 113. The host protocol processing section 102, the signal processing section 103, the wireless control section 104, the transmission weight generating section 105, the transmission processing section 106, and the reception processing section 107 are built from a CPU, a DSP, or the like.

The host protocol processing section 102 generates downlink communication data to be transmitted by the base station device 101.

The signal processing section 103 performs processing of allocating a frame to downlink communication data input from the host protocol processing section 102 and the like. The signal processing section 103 also generates reception data from a signal that is input from the reception processing section 107.

The wireless control section 104 allocates PRUs to mobile station devices. The wireless control section 104 notifies the transmission weight generating section 105 of results of allocating PRUs to mobile station devices.

The wireless control section 104 recognizes the presence of downlink communication data in each PRU by referring to results of PRU allocation.

The transmission weight generating section 105 generates a transmission weight control signal with which the phase and amplitude of signals to be transmitted from the antennas 110, 111, 112, and 113 are controlled, based on results of PRU allocation to mobile station devices which are notified from the wireless control section 104, and outputs the generated transmission weight control signal to the transmission processing section 106. Details thereof are described later.

The transmission processing section 106 performs processing such as encoding and modulation on downlink communication data generated by the host protocol processing section 102. The transmission processing section 106 also generates signals to be transmitted from the antennas 110, 111, 112, and 113, adjusts the generated signals based on a transmission weight control signal which is generated by the transmission weight generating section 105, and outputs the resultant signals to the transmission/reception module 108.

The transmission/reception module 108 performs processing such as upconvert on signals input from the transmission processing section 106, and outputs the resultant signals to the antennas 110, 111, 112, and 113. The transmission/reception module 108 also performs processing such as downconvert on signals input from the antennas 110, 111, 112, and 113, and outputs the resultant signals to the reception processing section 107.

The reception processing section 107 performs processing such as synchronization and demodulation on signals input from the transmission/reception module 108, and outputs the resultant signals to the signal processing section 103. The reception processing section 107 also outputs signals that have not been demodulated to the wireless control section 104.

The memory 109 saves data, a parameter, and the like that are used in the base station device 101.

Details of the transmission weight generating section 105 are described below. The transmission weight generating section 105 generates a transmission weight control signal with which the phase and amplitude of signals to be transmitted from the antennas 110, 111, 112, and 113 are controlled. With the transmission weight control signal, the transmission beampattern of signals transmitted from the base station device 101 is controlled.

The base station device 101 communicates based on the allocation of PRUs to mobile station devices by the wireless control section 104. When there is downlink communication data in a PRU that is allocated to a mobile station device, the transmission weight generating section 105 generates a transmission weight control signal for turning the transmission beam pattern of a signal in the PRU allocated to the mobile station device into a transmission beam pattern that enables the signal to reach at least the mobile station device.

When a PRU shifts from a state in which there is downlink communication data in one frame prior to a state in which there is no downlink communication data in the next frame, the base station device 101 transmits signals containing dummy data (DTX signals) in the PRU. In this manner, the base station device 101 raises the interference level in the PRU which is detected through carrier sense performed by another mobile station device, to thereby prevent a neighboring base station device and the mobile station device from starting communication that uses the PRU.

The transmission of the DTX signals is executed for the duration of a given period of time (retention period) which is set in advance. With the point in time at which the PRU shifts from a state in which there is downlink communication data in one frame prior to a state in which there is no downlink communication data in the next frame as the startingpoint, the DTX signals are transmitted for the duration of the retention period of the PRU. After the retention period elapses, the DTX signals are no longer transmitted and the PRU is released.

The transmission weight generating section 105 generates, for each PRU, a transmission weight control signal for changing the transmission beam pattern by adjusting the phase and amplitude of signals to be transmitted from the antennas 110, 111, 112, and 113.

FIGS. 2, 3, and 4 are diagrams illustrating transmission beam patterns (diagrams expressing the levels of transmission from a base station device toward 360-degree directions, with the base station device at the center) that are formed by the plurality of antennas 110, 111, 112, and 113 in the transmission of DTX signals. First, the transmission weight generating section 105 generates a transmission weight control signal that gives the transmission beam pattern in a PRU in question a shape illustrated in FIG. 2. The transmission weight generating section 105 generates a transmission weight control signal that gives the transmission beam pattern in the PRU a shape illustrated in FIG. 3 in the next frame. The transmission weight generating section 105 then generates a transmission weight control signal that gives the transmission beam pattern in the PRU a shape illustrated in FIG. 4 in the next frame. In short, DTX signals are transmitted sequentially with the use of different transmission beam patterns. Transmission processing that uses transmission beam patterns generated in this manner is called omni transmission processing.

Transmission weights that implement those transmission beam patterns are stored in advance in the memory 109. The transmission weight generating section 105 generates a transmission weight control signal based on the transmission weights.

Based on a transmission weight control signal generated in this manner, the transmission processing section 106 adjusts the phase and amplitude of signals to be transmitted from the antennas 110, 111, 112, and 113, and then performs fast Fourier transform (FFT). For a PRU in which downlink communication data is present with respect to a mobile station device, the transmission processing section 106 makes an adjustment such that the downlink communication data is transmitted with a transmission beam pattern directed to the mobile station device using the plurality of antennas 110, 111, 112, and 113. When the PRU shifts from a state in which there is downlink communication data to a state in which there is no downlink communication data, the transmission processing section 106 performs omni transmission processing in which DTX signals containing dummy data are transmitted omnidirectionally for the duration of three frames using the plurality of antennas 110, 111, 112, and 113 in the same PRU as that having been used to transmit the downlink communication data.

The transmission beam patterns of FIGS. 2, 3, and 4 have shapes that compensate one another in terms of null direction. Therefore, by executing transmission using each of those transmission beam patterns once, DTX signals are transmitted omnidirectionally over a transmission distance that is equal to or longer than a given distance. The transmission weight generating section 105 varies the transmission beam pattern by repeating FIGS. 2, 3, and 4 in order and, accordingly, by executing this omni transmission processing for three frames, DTX signals are transmitted omnidirectionally at least once for a transmission distance that is equal to or longer than a given distance (at a transmission power equal to or larger than a given value). The retention period in which omni transmission processing is executed is therefore set to a period equal to or longer than three frames.

An operation of the base station device 101 is described next with reference to a flow chart. FIG. 5 is a flowchart illustrating the operation of the base station device 101 according to this embodiment.

The base station device 101 determines, for every PRU, whether or not the PRU can be allocated to communication that is to be executed in the next frame.

The base station device 101 first checks for a PRU whether or not the PRU is in a retention period set for the base station device 101 itself or the PRU is being used for communication by the base station device 101 itself (S501).

In the case where the PRU is in a retention period set for the base station device 101 itself or the PRU is being used for communication by the base station device 101 itself, the PRU can be allocated to communication in the next frame as well, and therefore the base station device 101 checks whether or not there is a mobile station device to which the PRU should be allocated in the next frame (S504).

In the case where a mobile station device is found in S504, the base station device 101 allocates the PRU to communication with this mobile station device (S506). Specifically, the base station device 101 determines that a downlink communication signal is to be transmitted in the PRU in the next frame through the configuration of this embodiment, and finishes the determination for the PRU.

Finishing the determination for the PRU, the base station device 101 checks whether or not the determination has been completed for every PRU (S509) and, if not, changes the determination target to a PRU for which the determination has not been executed (S510) and returns to S501.

In the case where, in S501, the PRU is not in a retention period set for the base station device 101 itself and the PRU is not being used for communication by the base station device 101 itself, the base station device 101 checks results of carrier sense of the PRU in order to determine whether or not the PRU can be used for new communication (S502).

The base station device 101 judges results of carrier sense (S503) and, when it is determined that the PRU is available for use, the base station 101 proceeds to S504 to check whether or not there is a mobile station device to which the PRU should be allocated in the next frame. The subsequent steps are as described above.

When it is determined from the results of the carrier sense that this PRU is not available for use, the base station device 101 determines that the PRU is to be released in the next frame (S508), finishes the determination for the PRU, and proceeds to S509. The subsequent steps are as described above.

When a mobile station device to which the PRU shouldbe allocated is not found in S504, the base station device 101 checks whether or not the PRU is to be in a retention period set for the base station device 101 itself in the next frame (S505).

In the case where the PRU is to be in a retention period set for the base station device 101 itself in the next frame, the base station device 101 determines that DTX signals are to be transmitted in the PRU in the next frame through the configuration of this embodiment (S507), finishes the determination for the PRU, and proceeds to S509. The subsequent steps are as described above.

In the case where the PRU is not to be in a retention period set for the base station device 101 itself in the next frame, the base station device 101 determines that the PRU is to be released in the next frame (S508). The subsequent steps are as described above.

When the determination is completed for every PRU in S509, the base station device 101 finishes PRU determination processing for the current frame.

With the configuration described above, when a state in which there is no downlink communication data lasts for three frames or longer, DTX signals are transmitted omnidirectionally at least once in the three frames.

The present invention is not limited to the embodiment described above, and various modifications may be made without departing from the spirit of the present invention.

For example, while this embodiment describes a configuration in which dummy data transmission and other types of processing are executed in a PRU allocated to a mobile station device, the processing may instead be executed in a frequency band allocated to a mobile station device.

This embodiment describes a configuration in which the transmission beam pattern is switched at the head of a frame, but when to switch the transmission beam pattern is not limited thereto. Instead of switching the transmission beam pattern, a configuration in which the transmission beam pattern is rotated may be employed. In the case of rotating the transmission beam pattern, the configuration employed may be one in which the transmission beam pattern is rotated once in a retention period (given period), or one in which the transmission beam pattern is rotated by an angle that allows omnidirectional transmission for a given distance or longer in a retention period (given period).

This embodiment describes a configuration in which omni transmission processing is executed during a retention period. Alternatively, a configuration may be employed in which omni transmission processing lasts until the PRU shifts from a state in which no downlink communication data exists to a state in which downlink communication data is present.

1. A base station device provided with a plurality of antennas comprising:
data recognizing means for recognizing presence of downlink communication data with respect to a mobile station device; and
transmission means for:
transmitting the downlink communication data to the mobile station device by using the plurality of antennas, when the downlink communication data is present; and
performing omni transmission processing in which dummy data is transmitted omnidirectionally at least once by using the plurality of antennas at the same frequency as is used for the downlink communication data, when the downlink communication data is not present.

2. The base station device according to claim 1, wherein the omni transmission processing is executed for a duration of a given period of time.

3. The base station device according to claim 1, wherein the omni transmission processing is executed until the base station turns from a state in which the downlink communication data is not present turns into a state in which the downlink communication data is present.

4. The base station device according to claim 1, wherein the dummy data is transmitted during the omni transmission processing by using different transmission beam patterns sequentially.

5. The base station device according to claim 1, wherein the dummy data is transmitted by using a transmission beam pattern that rotates at least once during the omni transmission processing.

6. The base station device according to claim 1, wherein the transmission means transmits the dummy data in the same time slot as is used for the downlink communication data.

7. A method of controlling a base station device provided with a plurality of antennas comprising the steps of:
recognizing presence of downlink communication data with respect to a mobile station device;
transmitting the downlink communication data to the mobile station device by using the plurality of antennas, when the downlink communication data is present; and
performing omni transmission processing in which dummy data is transmitted omnidirectionally at least once through the plurality of antennas at the same frequency as is used for the downlink communication data, when the downlink communication data is not present.
